(19) United States
(12) Patent Application Publication
(10) Pub. No.: US 2005/0203236 A1
(43) Pub. Date: Sep. 15, 2005

(54) Reinforcing filler for silicone rubber and sealants

(76) Inventors: Christina Prowell, Warner Robins, CA (US); Scott Schurmann, Sayreville, NJ (US); Ashok Khokhani, Manalapan, NJ (US)

Correspondence Address: ENGELHARD CORPORATION, 101 WOOD AVENUE, ISELIN, NJ, 08830, US

(21) Appl. No.: 10/796,586

(22) Filed: Mar. 9, 2004

(51) Int. Cl. C08K 9/00; C08K 3/34

(52) U.S. Cl. 524/447; 523/216

(57) ABSTRACT

A silicone resin composition is provided which includes a silicone resin such as a silicone elastomer and a particulate kaolin filler which has been pretreated with an amino- or vinyl-functionalized organosilane or organosiloxane. The treated particulate kaolin filler can be used as reinforcement for silicone resin replacing silica fillers typically used for reinforcement.

### FIELD OF THE INVENTION

This invention relates to a method of improving the heat stability of silicone resins and the improved silicone resin composition formed thereby.

### BACKGROUND OF THE INVENTION

Elastomeric materials based upon polyorganosiloxane polymers are increasingly growing in demand in part due to the usefulness thereof at elevated temperatures. Polyorganosiloxane resins such as elastomers provide heat stable vulcanates that show resistance to the effects of elevated temperatures. In spite of the inherent heat stability of the polyorganosiloxane polymers, much work has been done to improve the heat stability of silicone resins for use in applications demanding prolonged exposure to elevated temperatures or for applications in which replacement of resin parts would be difficult. In addition, with ever increasing competition in the elastomers industry, more and more applications are being developed which require the elastomers to have increasingly improved mechanical and chemical properties including improved heat stability, hardness, tensile strength, tear strength, etc. Often, the improved properties are obtained by the inclusion of particulate filler materials.

For example, silicone rubbers formed mainly from cured polydiorganosiloxane fluids or gums alone generally have low tear and tensile strength values. However, these physical properties are often improved by incorporating a reinforcing filler into the fluid or gum prior to curing. Useful reinforcing and extending fillers are well known in the art. These include, but are not limited to, fumed silica, precipitated or wet silica, ground quartz, aluminum hydroxides (aluminum trihydrate), and carbon black. Other naturally occurring materials such as diatomaceous earth and clay are mentioned, but not widely practiced. Kaolin, in particular, is taught to improve the heat stability of specific compounds further reinforced with certain silicas. For example, U.S. Pat. No. 4,677,141, assigned to Dow Corning, discloses a silicone elastomer that is reinforced with silica and has improved heat stability by the addition of a white clay pretreated so that the surface of the clay contains olefinic unsaturated siloxy groups. A typical pretreated clay is a calcined kaolin.

A brochure entitled “Silane Coupling Agents in Mineral-Reinforced Elastomers,” published by Union Carbide Corporation, marked F-44715B, suggests that fillers such as calcined clays treated with vinyl functional silanes can be added to mineral-filled peroxide-cured elastomers, including silicone elastomers, to improve the mechanical and dynamic properties of elastomers. There is no teaching as to a method of improving the heat stability of silicone elastomers. Such treated inorganic fillers have been used in polyester resins, cross-linked polyethylene, ethylene-propylene rubber, and ethylene-propylene terpolymers to give products having improved physical properties.

A problem with using untreated clay filler as an ingredient for silicone rubber compositions, as well as with other fillers commonly employed in silicone rubber compositions, for example fumed and precipitated silica, is a tendency to interact with the polydiorganosiloxane fluid or gum causing a phenomenon typically referred to as “crepe hardening.” Much effort has been made to treat the surface of reinforcing fillers with organosilanes or organosiloxanes to render the surface hydrophobic, reduce or diminish the tendency of the compositions to crepe harden, and thus improve the physical properties of the cured silicone rubber.

For example, U.S. Pat. No. 3,015,645 teaches the preparation of hydrophobic silica powders by reacting an organosilicon compound such as dimethyidichlorosilane or trimethylmethoxysilane with a silica organogel in the presence of an acidic catalyst to form a hydrophobic silica hydrogel. The hydrophobic silica hydrogel is contacted with a water-immiscible organic solvent to convert the hydrophobic silica hydrogel to a hydrophobic silica organogel which segregates into the organic phase.

U.S. Pat. No. 4,072,796 describes a method in which finely divided hydrophobic silica and silicates are prepared by precipitating alkali silicate solutions with mineral acids or metal salt solutions and treated with organohalosilanes selected from prepolycondensed organohalosilane and a mixture of prepolycondensed organohalosilanes.

U.S. Pat. No. 5,009,874 describes a method for making a hydrophobic precipitated silica useful as a reinforcing filler in silicone elastomers. An organosilicon compound is added to a suspension of the precipitated silica to hydrophobe the silica, followed by addition of a water-immiscible organic solvent to separate the hydrophobic precipitated silica from the aqueous phase.

In accordance with U.S. Pat. No. 6,136,994, there is provided a method for preparing a hydrophobic clay, which method comprises:
(A) allowing a clay to be rendered hydrophobic by contacting an aqueous suspension of the clay with an organosilicon compound in the presence of an acid and a water-miscible solvent, wherein the organosilicon compound is selected from (i) organosilanes of formula R¹_{α}SiX_{4-α} wherein each R¹ is independently selected from hydrogen and optionally substituted hydrocarbon radicals having 1 to 12 carbon atoms, each X is independently selected from halogen and alkoxy radicals having 1 to 12 carbon atoms, and a=1, 2, or 3, and (ii) organosiloxanes comprising units of formula R²ₙSiO_{(4-n)/2} wherein each R² is independently selected from hydrogen, hydroxy, and hydrocarbon radicals having 1 to 12 carbon atoms, at least 50 mole percent of the R² substituents being hydrocarbon radicals, and n is 2 or 3, and
(B) contacting the clay suspension formed in step (A) with a water-immiscible solvent to effect separation of the hydrophobed clay from the suspension. Clay refers to various forms of hydrated alumino silicate, e.g. those hydrated alumino silicates of general formula Al₂O₃SiO₂.xH₂O, where x is the degree of hydration. Commonly known examples of clays include Fuller's Earth, bentonite, kaolin (China clay), and diatomite. A preferred clay for use in the invention is kaolin. In the organosilane (i) each R¹ may be, for example, an alkyl radical methyl, ethyl, propyl, t-butyl, hexyl, heptyl, oxtyl, decyl, and dodecyl; an alkenyl radical such as vinyl, allyl, and hexenyl; or an aryl radical such as phenyl, naphthyl, and tolyl. When the organosilane (i) contains X as either a halogen or an alkoxy group, R¹ may be substituted by one or more halogen atoms, for example R¹ may be a halogen substituted alkyl radical such as chloromethyl, 3,3,3-trifluoropropyl, and 6-chlorohexyl, and R¹ may contain a heteroatom in the hydrocarbon chain, for example to form a disulphide or polysulphide group. When the organosilane (i) contains X only as an alkoxy group, R¹ may also be organofunctional substituted, for example by mercapto, amino, carboxylic acid, ester, or amido groups. Each R¹ is preferably an alkyl radical. Each X in the above formula is independently selected from halogen and alkoxy radicals having 1 to 12 carbon atoms. As a halogen X is preferably chlorine. As an alkoxy radical X may be, for example, methoxy, ethoxy, or propoxy, preferably methoxy or ethoxy.

To date, however, specific silica fillers have been the only types of fillers that could provide the needed reinforcement in polyorganosiloxane polymers. Unfortunately, silica fillers such as fumed and precipitated silicas contained in an elastomeric system contribute greatly to the cost of the compound, as such silicas are often quite expensive on a per pound basis. Furthermore, fumed and precipitated silicas present handling issues during incorporation into the elastomeric system, especially with regards to dusting.

### SUMMARY OF THE INVENTION

Silicone elastomers have become commercial products, in part based upon their inherent resistance to the effects of exposure to elevated temperatures. Since their early commercialization, efforts have taken place to improve the physical properties and heat stability of silicone elastomers. The method of this invention provides improved heat stability to certain silicone elastomers. This method has an added advantage in that it produces silicone elastomeric compositions having improved physical properties and heat stability without the use of expensive silica fillers which have typically been used.

The silicone elastomers of this invention having improved heat stability comprise a mixture of a silicone resin and a specified pretreated kaolin. The use of the pretreated kaolin in conjunction with the silicone resin has yielded unexpected improvements in heat stability and physical properties for the resulting silicone elastomer. Pretreatment of the kaolin is provided by coating the kaolin particles with an amino- or vinyl-functionalized organosilane or organosiloxane. In this invention, the pretreated kaolin acts as a reinforcing filler for the silicone resin and thus there is no need to add expensive silica reinforcement. The improvement in heat stability is further obtained without sacrificing the ability of the silicone resin to be pigmentable. For the purposes of this invention, “pigmentable” is defined as the ability of the silicone elastomers to be mixed with various pigments to obtain desired colors or hues, including such colors as white or yellow. A particular use of the pigmentable silicone elastomers of this invention is as insulation on electrical wiring. It is necessary to be able to produce such insulation in a variety of colors, including such light colors as white or yellow, and to be able to easily distinguish between such colors as green and blue and black.

### DETAILED DESCRIPTION OF THE INVENTION

The silicone resins useful in this invention are commercially available in several embodiments. The nature of the organosilicon compounds that may be reinforced, after vulcanization, by the pretreated kaolin particles of the invention is not critical. In general, the organosilicon compositions are elastomeric or pasty in nature.

In the case of elastomer compositions, the vulcanizable organosilicon compound is such that if R designates the hydrocarbon radicals bonded to the silicon atoms, the ratio of the total number of R radicals to the number of total silicon atoms ranges from 0.5 to 3. In the constitution of organosilicon polymers, the other available silicon valences are bonded to heteroatoms, such as oxygen or nitrogen, or to multivalent hydrocarbon radicals.

Preferably, the filled organosilicon compositions according to the invention are organic polysiloxane compositions in which the organic polysiloxane is linear or branched, and optionally may contain, in addition to the hydrocarbons radicals, certain reactive groups, such as, for example, hydroxyl groups, hydrolyzable groups, alkenyl groups, hydrogen atoms, etc.

More precisely, the organic polysiloxanes which constitute the principal components of the compositions according to the invention, include siloxane units of the following general formula:
RₙSiO_{(4-n)/2} (I)
optionally combined with siloxane units of the formula:
ZₓR_{y}SiO_{(4-x-y)/2} (II)
In these formulae the different symbols have the following significance:

R represents a nonhydrolyzable hydrocarbon group, which may be an alkyl or halogenated alkyl radical having 1 to 5 carbon atoms and containing 1 to 6 chlorine and/or fluorine atoms, a cycloalkyl or halogenated cycloalkyl radical having 3 to 8 carbon atoms and containing 1 to 4 chlorine and/or fluorine atoms, an aryl, alkylaryl or halogenated aryl radical having 6 to 8 carbon atoms and containing 1 to 4 chlorine and/or fluorine atoms, or a cyanoalkyl radical having 3 to 4 carbon atoms; Z is a hydrogen atom, an alkenyl group, a hydroxyl group, a hydrolyzable atom, or a hydrolyzable group; n is an integer equal to 0, 1, 2 or 3; x is an integer equal to 0, 1, 2 or 3; and y is an integer less than or equal to 2.

The following are representative of such organic radicals directly bonded to the silicon atoms:

methyl; ethyl; propyl; isopropyl; butyl; isobutyl; alpha-pentyl; t-butyl; chloromethyl; dichloromethyl; alphachloroethyl; alpha,beta-dichloroethyl; fluoromethyl; difluoromethyl; alpha,beta-difluoroethyl; 3,3,3-trifluoropropyl; trifluorocyclopropyl; 4,4,4-trifluorobutyl; 3,3,4,4,5,5,5-heptafluoropentyl; beta-cyanoethyl; gammacyanopropyl; phenyl; p-chlorophenyl; m-chlorophenyl; 3,5dichlorophenyl; trichlorophenyl; tetrachlorophenyl; o-, p- or m-tolyl; alpha,alpha,alpha-trifluorotolyl; xylyls, such as 2,3-dimethylphenyl; 3,4-dimethylphenyl; and the like.

Preferably, the organic radicals bonded to the silicon atoms are methyl, phenyl or vinyl radicals; these radicals may optionally be halogenated or may be cyanoalkyl radicals.

The symbols Z are advantageously hydrogen, chlorine atoms, fluorine atoms, vinyl groups, hydroxyl groups or hydrolyzable groups, such as amino, amido, aminoxy, oxime, alkoxy, alkoxyalkoxy, alkenyloxy, acyloxy groups, and the like.

The nature of the organic polysiloxane and thus the ratios of the siloxane units (I) and (II) and their distribution are selected in known manner as a function of the intended application and of the vulcanization treatment to which the composition is to be subjected. While organic polysiloxane resins which are vulcanized to silicone elastomers have found wide commercial use and are of particular importance in this invention, lower molecular weight organic polysiloxanes ranging from oils to gum-like consistency can be improved by the addition of the pretreated kaolin filler of this invention.

They may, therefore, include compositions vulcanizable at elevated temperatures under the action of organic peroxides, such as 2,4-dichlorobenzoyl peroxide, benzoyl peroxide, t-butyl perbenzoate, cumyl peroxide, di-t-butyl peroxide, and the like.

The organopolysiloxane comprising such compositions includes essentially only siloxane units (I) and contains no hydrolyzable groups or atoms.

The polymethylpolysiloxanes terminated by trimethylsilyl end groups constitute a particularly preferred embodiment of the invention on an industrial level.

Vulcanization may also be carried out at ambient temperature or at a moderate temperature by effecting cross-linking between vinylsilyl groups and hydrogenosilyl groups, with the hydrosilylation reaction being conducted in the presence of catalyst, such as platinum derivatives; the organic polysiloxanes then contain no hydrolyzable atoms or groups.

Vulcanization may be carried out under the action of humidity. The organic polysiloxanes contained in compositions of this type contain hydrolyzable atoms or groups, such as those defined above. The siloxane units (II) contained in such groups constitute at most 15% by weight of the total weight of the organic polysiloxanes employed. Organic polysiloxane compositions of this type generally contain catalysts, such as tin salts.

Finally, vulcanization may be carried out in the presence of crosslinking agents. The organic polysiloxanes comprising such compositions generally are linear, branched or crosslinked polysiloxanes consisting of units (I) or (II), wherein Z is a hydroxyl group and x is equal to at least 1. The crosslinking agent may be a polyfunctional silane such as methyltriacetoxysilane, isopropyltriacetoxysilane, vinyltriacetoxysilane, trimethyl(diethylaminoxy)silane. Various other compounds, e.g., the silicates may also be used as crosslinking agents.

The other critical ingredient present in the silicone elastomeric compositions used in the method of this invention is a pretreated kaolin having a surface area of less than 50 m²/g. The surface area of fillers typically varies with the particle size of the filler and is useful in describing the physical nature and size of small particles. As the particles become smaller, the surface area generally increases. In this invention, the surface of the kaolin is treated with an amino- or vinyl-functionalized organosilane or organosiloxane In general, various clay materials can be pretreated with an amino or vinyl silane or siloxane and used to reinforce the silicone resin. Suitable clays are the aluminum silicate minerals which are commercially mined and refined for use as fillers in paints, plastics, and elastomers. Clays are further defined as illite, kaolinite, and montmorillonite, all of which are complex aluminum silicate minerals. Kaolinite, or kaolin, is preferred because it is readily available in a white form. The kaolin useful in this invention does not color the silicone elastomeric composition and permits the silicone elastomeric composition to be pigmented or colored to the desired hue. When a suitable clay is mixed into the silicone elastomeric composition, the composition may be changed to a cream color, but it is still easily pigmented as the clay has low hiding power and low tint strength.

The kaolin filler is pretreated before compounding or otherwise mixing with the silicone resin so that the surface of the kaolin contains silane or siloxane groups. The kaolin reinforcing filler of this invention is preferably a calcined kaolin having an average particle size of less than 10 microns, typically less than 2 microns, and can be less than 1 micron as measured by sedimentation particle sizing instrumentation utilizing Stokes Law available from Micromeretics. A typical kaolin particulate filler useful in this invention will have a particle size of from 0.75 to 1.5 microns. Calcined or uncalcined kaolin can be used as the reinforcing filler of this invention. A calcined kaolin is preferred.

As little as 30 parts by weight of pretreated kaolin per 100 parts silicone resin is useful in improving the heat stability and providing reinforcement of the silicone elastomer of this invention. Increasing the amount of pretreated kaolin to 40 or 60 parts by weight of kaolin to 100 parts by weight of silicone resin further improves the heat stability. Up to 200 parts of pretreated kaolin added to 100 parts by weight silicone elastomer also yields a silicone elastomer having improved heat stability. The retention of physical properties may not be as high in the case of a composition using a large amount of pretreated kaolin as when a smaller amount is used.

The preferred amount of pretreated kaolin to be used in the method of this invention is dependent upon the requirement of the cured silicone elastomer, as well as the other ingredients used in the silane elastomeric composition. The optimum amount of the various ingredients is easily determined by simple experimentation.

The kaolin for incorporation into the silicone resin, whether in a calcined or uncalcined state, is advantageously surface treated with at least greater than 1.0% by weight of (i) the organosilane or (ii) organosiloxane of this invention. Levels of at least 1.10% by weight and at least 1.20% by weight, but generally not more than 12% by weight, based on the weight of dry treated kaolin of the (i) silane or (ii) siloxane are particularly useful.

For the organosilanes (i) of formula R¹ₐSiX₄₋ₐ, each R¹ is independently selected from hydrogen and hydrocarbon radicals having 1 to 12 carbon atoms. At least one R¹ must be an amino- or vinyl-substituted hydrocarbon radical. For example, R¹ may be a monovalent hydrocarbon radical which is saturated or unsaturated, and/or which is substituted or unsubstituted. Each R¹ may be, for example, an alkyl radical such as methyl, ethyl, propyl, t-butyl, hexyl, heptyl, octyl, decyl, and dodecyl. At least one R¹ may be an amino-substituted alkyl such as aminopropyl; or an alkenyl radical such as vinyl or allyl. For example, at least one R¹ may be hexenyl or vinyl propyl. R¹ may be an aryl radical such as phenyl, naphthyl, and tolyl, so long as at least one R¹ group is amino- or vinyl-substituted. Each X in the above formula is independently selected from halogen and alkoxy radicals having 1 to 12 carbon atoms. As a halogen X is preferably chlorine. As an alkoxy radical X may be, for example, methoxy, ethoxy, and propoxy, preferably methoxy or ethoxy.

For the organosiloxanes (ii) comprising units of formula R²ₙSiO_{(4-n)/2}, each R² is independently selected from hydrogen, hydroxy, and hydrocarbon radicals having 1 to 12 carbon atoms, at least 50 mole percent of the R² substituents being hydrocarbon radicals, preferably methyl groups. Moreover, at least one of the R² substituents must be an amino- or vinyl-substituted hydrocarbon radical. For example, R² may be an alkyl, amino-substituted alkyl, alkenyl or aryl group as described above for R¹. The organosiloxanes (ii) can be linear or cyclic, and their viscosity can range from that of a fluid to a gum.

Some of the useful amino organosilanes are disclosed along with methods for their preparation in U.S. Pat. Nos. 2,832,754; 2,930,809; 3,007,957; and 3,020,301. Commercially available aminoorganosilanes include “A-1100” (gamma aminopropyltriethoxysilane) sold by Union Carbide Corporation, New York, N.Y., and “Z-6020” (a diamino functional silane) sold by Dow Corning Corporation, Midland, Mich. or “A-1120” (a diamino functional silane) sold by Union Carbide Corporation.

Other suitable organosilicon compounds include allylmethyidichlorosilane, trivinyltrimethylcyclotrisiloxane, divinyldipropoxysilane, vinyldimethylchlorosilane, vinylmethyldichlorosilane, vinyldimethylmethoxysilane, vinylpropyltriethoxysilane, hexenylmethyldichlorosilane, hexenyldimethylchlorosilane, polydimethylsiloxane, or polymethylhydrogensiloxane polymers having a viscosity within a range of about 1 mpa.s to 1,000 mpa.s at 25° C., wherein one or more of the methyl groups is replaced with an amino- or vinyl-functional alkyl group.

The surface treatment can take place via direct exposure of dry kaolin to the neat organosilane or organosiloxane, or an emulsion containing the same. Alternatively, the surface treatment can take place in slurry form, contacting the silane, siloxane, or an emulsion thereof with the kaolin slurry, followed by subsequent drying and pulverization. However, this does not yield improved product when compared to that where the reaction takes place on dry kaolin and represents significantly greater processing costs. Therefore, the preferred method is to react the silane or siloxane, either neat or as an emulsion, with dry kaolin in a suitable liquid/powder mixer.

The compositions of this invention, containing the pretreated kaolin used in this invention, can be pigmented to a desired or required color because the kaolin useful in this invention does not in itself color the composition. Many of the previously known methods of improving the heat stability of silicone elastomers relied upon the addition of materials which strongly colored the composition so that the choice of colors that could be produced was severely limited. The method of this invention thus produces a composition having both improved heat stability and pigmentability through the use of a commercially obtainable and low-cost ingredient. The combination of the specified silicone resin and the pretreated kaolin has been unexpectedly found to provide these advantages.

The compositions of this invention can be pigmented with the well-known pigments available for use with silicone elastomer. The pigments are heat stable and have little or no effect upon the properties of the vulcanized silicone elastomer. The pigments are normally inorganic oxides or salts which are finely dispersed in a silicone polymer to give a masterbatch which can be easily dispersed during the mixing of the silicone elastomeric composition.

The kaolin may impart a white or cream color to the finished composition. Even at very high loadings, the kaolin-reinforced silicone rubber retains its ability to be pigmented. A particular use of the elastomers resulting from this invention is insulation on electrical wiring. It is necessary to be able to produce such insulation in a variety of colors, including such light colors as white or yellow, and to be able to easily distinguish between such colors as green and blue and black because these colors are used primarily to identify wires.

The coated kaolin filler is mixed with the silicone resin in two stages. The first stage is incorporating the coated filler into the silicone resin such as from the feed hopper of an extruder, and the second stage is agitating the coated filler with the resin at elevated temperatures in a single screw or multiscrew extruder. Preferably, the coated filler is added downstream along the barrel of the extruder into the melted resin. After this treatment, the compositions are generally in the form of rods, which are then chopped into granules and the granules subsequently used to form the desired ultimate shaped articles in conventional injection molding, transfer molding, or extrusion molding apparatus.

Inorganic extending filler which has not been treated can optionally be added to the composition used in this method. The use of untreated inorganic extending filler will dilute the effect of using the pretreated kaolin so the relative amounts of kaolin and untreated inorganic extending filler must be judged by their effect upon the properties of the cured silicone elastomer. Inorganic extending fillers useful in silicone elastomers are well known in the art. The silicone elastomeric composition may also contain minor amounts of additive to improve the properties such as handling, compression set, oil resistance, etc. The additives preferably should be those which do not impart color to the composition unless the additive imparts a color which is desired.

The compositions may also contain, in addition to the polysiloxanes, the crosslinking agents and crosslinking catalysts, conventional fillers, such as pulverized quartz, diatomaceous earth, talc, carbon black, carbonates, and the like. The compositions may also contain different conventional additives, such as antistructural agents, heat stabilizers, thixotropic agents, pigments, corrosion inhibitors, etc.

The antistructural agents, also known as plasticizers, are generally organosilicon in nature and are introduced in a proportion of 0 to 20 parts per 100 parts of the organosilicon gum. They make it possible to slow the hardening of the compositions during storage. Among such antistructural agents, the silanes with hydrolyzable groups of low molecular weight, and the hydroxyl or alkoxy diorganopolysiloxane oils are representative. Such compositions are described, for example, in French Patent No. 1,111,969.

Among the heat stabilizers well known to this art, the salts, oxides and hydroxides of iron, cerium or manganese are exemplary. These additives, which may be used alone or in admixture, are generally introduced in a proportion of 0.01 to 5% relative to the weight of the organopolysiloxane resin.

The organopolysiloxane compositions are prepared by mixing together the different ingredients thereof, as described above. The mixture may be prepared at ambient temperature, or hot.

The silicone elastomers produced by the method of this invention are suitable for uses customarily known for silicone elastomers such as molded parts for high temperature applications, gaskets, O-rings, diaphragms, tubing, and insulated electrical wiring. Insulated electrical wiring can be easily colored to conform to the required color codes.

The following examples are included for illustrative purposes only and should not be construed as limiting the invention which is properly delineated by the appended claims. All parts are parts by weight.

### EXAMPLE 1

Calcined kaolin was surface modified with y-aminopropyltriethoxysilane in a suitable dry/liquid mixer. This surface modified kaolin at various weight levels was then incorporated into suitable silicone gum in a Banbury mixer. The resulting silicone base was freshened and catalyst incorporated on a two-roll mill. The compounded material was press cured for ten minutes at 170° C. Press cured plaques were post-cured in a forced air oven at 200° C. for 2 hours. The modified kaolin compositions were compared to compositions of silicone rubber containing fumed silica reinforcement. The composition formulas are shown in Table 1 wherein the type of filler incorporated into the composition is set forth in the top row of the table. Physical properties of the compositions are shown in Table 2 wherein the compositions are labeled by the types of filler added in the first column of the table.

TABLE 1

| | | Fumed |
|---|---|---|
| | Kaolin | Silica |
| VMQ Gum | 100 | 100 |
| PDMS Fluid | Varies | 0.24 |
| Filler | Varies | 30 |
| Peroxide | 1.1 | 1 |
| Catalyst | | |

VMQ gum = Dow Corning Q-2901
PDMS Fluid = Dow Corning Q4-2737
Peroxide Catalyst = Varox DBPH
Kaolin = M02-023, Engelhard
Fumed Silica = Aerosil 200, DeGussa

TABLE 2

| | | | | | Tear |
|---|---|---|---|---|---|
| | | Tensile | Elongation | Modulus | Strength, |
| | Hardness, | Strength, | at Break, | at 100% | Die B, |
| | ASTM | ASTM | ASTM | E, ASTM | ASTM |
| | D2240 | D412 | D412 | D412 | D624 |
| | Shore A | MPa | % | Mpa | kN/m |
| Aerosil 200 | 50 | 5.3 | 200 | 2.5 | 11.8 |
| M02-023, | 50 | 4.3 | 190 | 2.2 | 11.0 |
| 63 phr¹ | | | | | |
| M02-023, | 52 | 4.6 | 190 | 2.6 | 12.2 |
| 70 phr | | | | | |
| M02-023, | 60 | 5.0 | 170 | 3.5 | 14.3 |
| 90 phr | | | | | |
| M02-023, | 70 | 6.3 | 170 | 4.4 | 14.6 |
| 100 phr | | | | | |
| M02-023, | 74 | 6.5 | 140 | 5.1 | 12.9 |
| 120 phr | | | | | |
| M02-023, | 81 | 6.6 | 110 | — | 15.0 |
| 140 phr | | | | | |
| M02-023, | 86 | 6.7 | 90 | — | 16.6 |
| 160 phr | | | | | |

¹All modified kaolins contained 1.24 wt. % of aminosilane

At approximately 60% by weight addition of the pretreated kaolin, the silicone elastomer had the same hardness value as the silicone resin with fumed silica. Addition of larger amounts of the pretreated kaolin increased the hardness and tensile strengths of the silicone resin. Even at the higher levels of pretreated kaolin, the use of the pretreated kaolin yields an economic benefit relative to the fumed silica provided at lower amounts in as much as the fumed silica is an expensive filler. To be able to replace the fumed silica with the pretreated kaolin filler of the present invention yields not only an economic benefit but, as shown, an improvement in physical properties.

### EXAMPLE 2

### Kaolin-filled Silicone Rubber Showing Enhanced Heat Aged Properties

Calcined kaolin was surface modified with y-aminopropyltriethoxysilane in a suitable dry/liquid mixer. This surface modified kaolin was then incorporated into the silicone rubber of Example 1 in a Banbury mixer. The resulting silicone base was freshened and catalyst incorporated on a two-roll mill. The freshened material was press cured for ten minutes at 170° C. Press cured plaques were post-cured in a forced air oven at 200 C for 2 hours. This represented the control sample. The samples were then heat aged in a forced air oven for 70 hours at 232° C. (All units are % change from the control subsequent to heat aging, except hardness, which is in points).

| | | | | | Tear |
|---|---|---|---|---|---|
| | | Tensile | Elongation | Modulus | Strength, |
| | Hardness | Strength | at Break | at 100% | Die B |
| | ASTM | ASTM | ASTM | E ASTM | ASTM |
| | D2240 | D412 | D412 | D412 | D624 |
| | Shore A | Mpa % | % | Mpa | kN/m |
| Aerosil 200¹ | −8 | −500 | −30 | −29 | −4 |
| M02-023, | −2 | −6 | −8 | 1 | −9 |
| 63 phr² | | | | | |
| M02-023, | −3 | −10 | −6 | −9 | −21 |
| 70 phr | | | | | |
| M02-023, | 2 | −2 | −12 | −5 | −18 |
| 90 phr | | | | | |
| M02-023, | 0 | −7 | −13 | −4 | −19 |
| 100 phr | | | | | |
| M02-023, | 5 | −10 | −8 | −2 | −9 |
| 120 phr | | | | | |
| M02-023, | 5 | −9 | −10 | — | 10 |
| 140 phr | | | | | |
| M02-023, | 5 | −15 | −12 | — | — |
| 160 phr | | | | | |

¹Provided an amount of 30 wt. %
²All modified kaolin samples contained 1.24 wt. % aminosilane

It can be seen that the silicone resin with the pretreated kaolin filler of this invention maintained its properties after heat aging better than the fumed silica-filled resin.

### EXAMPLE 3

### Kaolin Filled Silicone Rubber Showing Improved Compression Set Properties

Additional test pieces from Example 1 were heat aged in an air-circulating oven for 22 hours at 171° C. according to ASTM D395B Type 1. The samples were then removed, adjusted to ambient and tested. Results are shown in the Table below.

| | Compression Set, |
|---|---|
| | ASTM D395B |
| | Type 1, % |
| Aerosil 200 | 37 |
| M02-023, 63 phr | 13 |
| M02-023, 70 phr | 11 |
| M02-023, 90 phr | 12 |
| M02-023, 100 phr | 14 |
| M02-023, 120 phr | 18 |
| M02-023, 140 phr | 21 |
| M02-023, 160 phr | 23 |

As can be seen, the silicone resin containing the pretreated kaolin filler of this invention had markedly improved compression set performance relative to the silicone resin filled with fumed silica.

### EXAMPLE 4

### Silicone Rubber Filled with Kaolins of Varying Surface Treatments

Calcined kaolin was surface modified with y-aminopropyltriethoxysilane in a suitable dry/liquid mixer at increasing treatment levels. This surface modified kaolin was then incorporated into silicone rubber of Example 1 in a Banbury mixer. The resulting silicone base was freshened and catalyst incorporated on a two-roll mill. The freshened material was press cured for ten minutes at 170° C. Press cured plaques were post-cured in a forced air oven at 200° C. for 2 hours. This represented the control sample. The samples were then heat aged in a forced air oven for 70 hours at 232° C. (All units are % change from the control, subsequent to heat aging, except hardness, which is in points.)

| | | | | | Tear |
|---|---|---|---|---|---|
| | | Tensile | Elongation | | Strength, |
| | Hardness | Strength | at Break | Modulus | Die B |
| Silane | ASTM | ASTM | ASTM | at 100% E | ASTM |
| Treatment | D2240 | D412 | D412 | ASTM | D624 |
| Level | Shore A | MPa | % | D412 Mpa | kN/m |
| A | −5 | −10.8 | −11.1 | −8.0 | −18.8 |
| B | −5 | −9.4 | −15.0 | −6.8 | −17.9 |
| C | −2 | +3.1 | −5.3 | +1.0 | −9.2 |

A = low treatment level, 0.8 wt. %
B = medium treatment level, 1.0 wt. %
C = high treatment level, 1.24 wt. %

1. A resin composition comprising a silicone resin containing a reinforcing amount of a particulate kaolin filler, said particulate kaolin filler having been pretreated so as to contain greater than 1.0 wt. % up to 12.0 wt. % of an amino- or vinyl-functionalized organosilane or organosiloxane.

2. The resin composition of claim 1 wherein said particulate kaolin filler has been pretreated so as to contain 1.1 to 12 wt. % of said organosilane or organosiloxane.

3. The resin composition of claim 1 wherein said particulate kaolin filler has been pretreated so as to contain 1.2 to 12 wt. % of said organosilane or organosiloxane.

4. The resin composition of claim 1 wherein said particulate kaolin filler is calcined.

5. The resin composition of claim 1 wherein said particulate kaolin filler has an average particle size of less than 10 microns.

6. The resin composition of claim 1 wherein said particulate kaolin filler has an average particle size ranging from 0.75 to 2.0 microns.

7. The resin composition of claim 1 comprising at least 30 parts by weight of said pretreated particulate kaolin filler per 100 parts of said silicone resin.

8. The resin composition of claim 1 containing at least 40 parts by weight of said pretreated kaolin filler to 100 parts by weight of said silicone resin.

9. The resin composition of claim 1 containing at least 60 parts by weight of said pretreated particulate kaolin filler per 100 parts of said silicone resin.

10. The resin composition of claim 1 containing up to 200 parts by weight of said pretreated particulate kaolin filler per 100 parts by weight of said silicone resin.

11. The resin composition of claim 1 wherein said silicone resin has a molecular weight such that the silicone ranges from a silicone oil to a silicone elastomer.

12. The resin composition of claim 11 wherein said silicone resin is a silicone elastomer.

13. The resin composition of claim 12 wherein said silicone elastomer is formed by vulcanizing at elevated temperatures.

14. The resin composition of claim 12 wherein said silicone elastomer is formed by vulcanization at ambient temperature.

15. The resin composition of claim 1 further including a pigment in addition to said pretreated particulate kaolin filler.

16. The resin composition of claim 1 being devoid of a silica filler.

17. The resin composition of claim 12 wherein said composition is devoid of a silica filler.

18. The resin composition of claim 1 wherein said kaolin is pretreated with an organosilane (i) of formula R¹ₐ SiX₄₋ₐ, wherein each R¹ is independently selected from hydrogen and hydrocarbon radicals having 1 to 12 carbon atoms, at least one R¹ is an amino- or vinyl-substituted hydrocarbon radical, and X is independently selected from halogen and alkoxy radicals having 1-12 carbon atoms, or an organosiloxane (ii) comprising units of formula R²ₙ SiO_{(4-n)/2}, wherein each R² is independently selected from hydrogen, hydroxy, and hydrocarbon radicals having 1 to 12 carbon atoms, at least one of the R² substituents is an amino- or vinyl-substituted hydrocarbon radical.

19. The resin composition of claim 1 wherein said pretreated kaolin filler contains an aminoalkylsilane.

20. The resin composition of claim 19 wherein said pretreated kaolin filler contains about 1.24 wt. % of said aminoalkylsilane.

21. The resin composition of claim 20 wherein said aminoalkylsilane is aminopropyltriethoxysilane.

22. A method of improving the heat stability and physical properties of a silicone resin comprising mixing with the silicone resin a reinforcing amount of a particulate aluminum silicate filler, said particulate filler having been pretreated prior to mixing with said silicone resin so as to contain at least 1.10 wt.% up to 12.0 wt. % of an amino- or vinyl-functionalized organosilane or organosiloxane.

23. The method of claim 22 wherein said particulate aluminum silicate filler is kaolin.

24. The method of claim 23 wherein said kaolin is calcined.

25. The method of claim 23 wherein said pretreated particulate kaolin filler is present in amounts of at least 30 to 200 parts by weight per 100 parts by weight of said silicone resin.

26. The method of claim 22 wherein said silicone resin is devoid of a silica filler.
